(19) United States
(12) Patent Application Publication
(10) Pub. No.: US 2024/0119093 A1
(43) Pub. Date: Apr. 11, 2024

(54) ENHANCED DOCUMENT INGESTION USING NATURAL LANGUAGE PROCESSING

(71) Applicant: International Business Machines Corporation, Armonk, NY (US)

(72) Inventors: Susan Hallen, Chicago, IL (US); Rose Fleischman, Poughkeepsie, NY (US); Alan Daet Mejía Villaseñor, Guadalajara (MX); Diane Helen Wasserstrom, Poughkeepsie, NY (US)

(21) Appl. No.: 17/961,069

(22) Filed: Oct. 6, 2022

(51) Int. Cl. G06F 16/9032; G06F 16/93; G06F 40/20

(52) U.S. Cl. CPC G06F 16/90332; G06F 16/93; G06F 40/20

(57) ABSTRACT

Methods, systems, and computer program products for enhanced document ingestion using natural language processing are provided herein. A computer-implemented method includes identifying, within a first document, terms unknown to a first natural language processing model by processing the first document using the first natural language processing model; identifying, within a second document, terms known to a second natural language processing model by processing the second document using the second natural language processing model; comparing the terms unknown to the first natural language processing model to the terms known to the second natural language processing model; and upon determining that at least one of the terms unknown to the first natural language processing model matches at least one of the terms known to the second natural language processing model, reprocessing the first document using the second natural language processing model.

### BACKGROUND

The present application generally relates to information technology and, more particularly, to language data processing. More specifically, with respect to natural language processing (NLP) techniques, changes to at least one model with such techniques, particularly if made outside of user control, can result in inaccurate and/or error-prone results. For example, conventional language processing techniques commonly attempt to manage such model changes by ignoring inaccurate or erroneous results and/or reprocessing all documents every time there is a known model change, a resource-intensive and time-intensive process.

### SUMMARY

In at least one embodiment, techniques for enhanced document ingestion using natural language processing are provided. An example computer-implemented method includes identifying, within at least a first document, one or more terms unknown to a first natural language processing model by processing the at least a first document using the first natural language processing model. The method also includes identifying, within at least a second document, one or more terms known to a second natural language processing model by processing the at least a second document using the second natural language processing model, and comparing the one or more terms unknown to the first natural language processing model to the one or more terms known to the second natural language processing model. Further, the method includes, upon determining, in connection with the comparing, that at least one of the one or more terms unknown to the first natural language processing model matches at least one of the one or more terms known to the second natural language processing model, reprocessing the at least a first document using the second natural language processing model.

Another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating an example workflow according to an example embodiment of the invention;

FIG. 2 is a diagram illustrating a flow diagram for an enhanced document ingestion methodology in connection with NLP techniques, according to an example embodiment of the invention;

FIG. 3 is a flow diagram illustrating techniques according to an example embodiment of the invention; and

FIG. 4 is a diagram illustrating a computing environment in which at least one embodiment of the invention can be implemented.

### DETAILED DESCRIPTION

As described herein, at least one embodiment includes improved document ingestion in connection with NLP techniques. Such an embodiment includes enhancing the manner in which documents are identified for re-ingestion when a given NLP model changes, which, for example, saves time and compute resources because it precludes the need to re-ingest all documents. In accordance with one or more embodiments, NLP techniques commonly include using at least one language model. Additionally, in at least one embodiment, a language model used in connection with NLP techniques can be overridden with a user-defined model and/or modified by one or more users. Also, as an NLP engine (also referred to herein as an artificial intelligence-based NLP engine) reads or ingests a given document, the NLP engine parses the text of the given document into various enrichments defined by the corresponding language model, wherein enrichments refer to categories and/or partitions (e.g., concepts, keywords, key phrases, etc.) into which the data, using the language model, is placed. Accordingly, as further detailed herein, one or more embodiments include modifying and/or enhancing NLP engines to provide additional data that can aid in identifying model changes. As used herein, an NLP engine refers to a set of software that transforms natural language data (e.g., human-readable data) to computer-structured data, analyzing and adding information to such data according to at least one NLP model. Accordingly, as used herein, NLP models are part of one or more NLP engines, used, for example, to identify meaning(s) of natural language data and how such data are going to be transformed into computer-structured data.

As such, at least one embodiment includes reducing the need for complete re-ingestion of all documents by an NLP engine when a model corresponding thereto changes, by identifying and re-ingesting only a particular sub-set of the documents. Such an embodiment includes adding and/or implementing at least one new and/or additional enrichment field to the ingested documents by the NLP engine, wherein unknown terms (e.g., one or more words) and/or phrases (also referred to within the context of NLP techniques as out-of-vocabulary (OOV)) are placed and/or annotated accordingly. Such terms and/or phrases are then gathered at ingestion time in at least one database for subsequent analysis and/or comparison when ingesting new and/or additional documents, so as to determine if one or more of the previous documents need to be re-ingested by the NLP engine.

By way of illustration, in one or more embodiments, a given NLP model will be able to identify unknown terms, which means the NLP engine is also able to identify unknown terms. For example, in such an embodiment, a storage unit (e.g., a database and/or other data structure) is updated every time a document is ingested, and then, obtaining known terms on the fly, a comparison is performed. If there are known terms matching the unknown terms in the storage unit, re-ingestion is triggered for already processed documents (also referred to herein as old documents) containing those unknown terms (including adding these new field “unknown” terms). Accordingly, in such an embodiment, unknown terms are known to the given NLP model and corresponding NLP engine, and such terms are stored in a storage unit and in each processed document.

As such, one or more embodiments include comparing known data of at least one ingested document to at least one set of unknown and/or additional terms gathered in at least one database. If one or more of the unknown and/or additional terms are deemed to be known based at least in part on the comparison (e.g., that one or more of the unknown and/or additional terms match one or more terms in the at least one ingested document), such an embodiment includes determining that the document(s) containing the one or more terms should be re-ingested by the given NLP engine, and automatically performing the re-ingestion task(s).

As noted, in one or more embodiments, at least one new and/or additional enrichment field (e.g., UNKNOWN) is added to an NLP engine for use when the NLP engine ingests documents. As the NLP engine ingests or processes a given document, the NLP engine identifies terms (e.g., nouns) within the given document that are unknown to the NLP engine (e.g., terms that are not present in the model(s) of the NLP engine and/or terms that have not appeared in previous ingested documents), as well as the context of such terms (e.g., subject, predicate, other language constructs surrounding the term, etc.). Such an embodiment includes storing the identified terms into the new and/or additional enrichment field of the processed document.

Additionally, in connection with such an embodiment, when analyzing one or more documents ingested by a new model and/or modified version of a model in connection with one or more documents ingested by a previous model and/or previous version of a model, should one or more of the stored enrichment field terms appear in the one or more documents ingested by a previous model and/or previous version of a model, then the corresponding previously ingested document is identified as needing to be re-ingested with the new model and/or modified version of the model. In cases wherein at least one of the stored enrichment field terms from one or more documents ingested by a previous model and/or previous model version matches one or more known terms from the one or more documents ingested by a new model and/or modified version of a model, a re-ingestion of the one or more documents ingested by a previous model and/or previous model version can be performed.

Further, to identify one or more changes made to a given machine learning model and/or neural network model of a given NLP engine, at least one embodiment includes running one or more test cases comparing stored UNKNOWN enrichments (i.e., stored terms unknown to the model) against KNOWN enrichments from a document (i.e., terms known to the model), and if there are changes and/or terms that do not match, the NLP engine determines if there are needs to re-ingest one or more additional documents.

Accordingly, as detailed herein, one or more embodiments includes adding and/or implementing a new and/or additional enrichment field to be used in connection with at least one NLP engine, wherein the new and/or additional enrichment field corresponds with terms and/or phrases that are unknown to at least one language model used by the NLP engine. Additionally, such terms and/or phrases stored in association with the new and/or additional enrichment field are analyzed and/or compared against when the NLP ingests new documents to determine if one or more previously ingested documents need to be re-ingested.

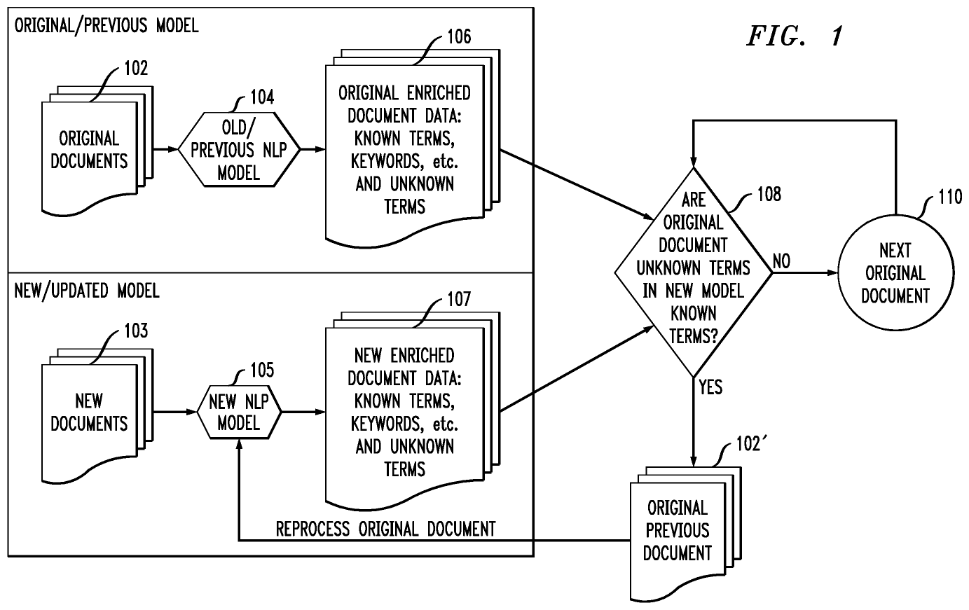

FIG. 1 is a diagram illustrating an example workflow according to an example embodiment of the invention. By way of illustration, FIG. 1 depicts original documents 102, which are processed or ingested by original/previous NLP model 104, resulting in original enriched document data 106 (e.g., concepts known to NLP model 104, terms known to NLP model 104, and terms unknown to NLP model 104). Additionally, FIG. 1 depicts new documents 103, which are processed or ingested by new/updated NLP model 105, resulting in new enriched document data 107 (e.g., concepts known to NLP model 105, terms known to NLP model 105, and terms unknown to NLP model 105).

As also depicted in FIG. 1, step 108 includes determining whether any unknown terms from original enriched document data 106 associated with a first of the original documents 102 match any known terms from new enriched document data 107. If no (that is, no unknown terms from original enriched document data 106 associated with a first of the original documents 102 match any known terms from new enriched document data 107), then the workflow continues to step 110, which includes repeating the step 108 analysis with at least a second of the original documents 102. If yes (that is, at least one unknown term from original enriched document data 106 associated with a first of the original documents 102 matches one or more known terms from new enriched document data 107), then the first original document 102′ is re-ingested or reprocessed by new/updated NLP model 105.

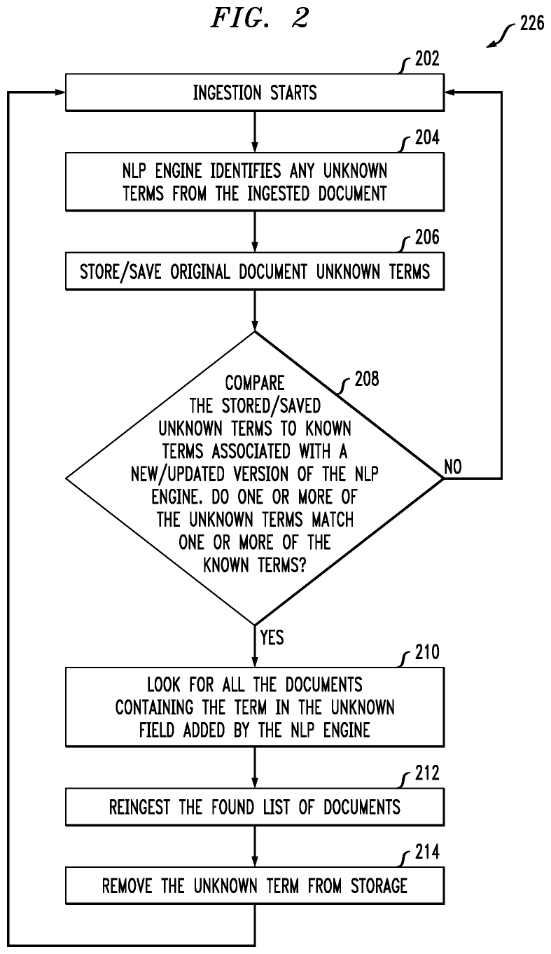

FIG. 2 is a diagram illustrating a flow diagram for an enhanced document ingestion methodology 226 in connection with NLP techniques, according to an example embodiment of the invention. By way of illustration, step 202 includes starting ingestion of a document by an NLP engine. In step 204, the NLP engine identifies any unknown terms from the ingested document, and step 206 includes storing and/or saving the unknown terms (e.g., in at least one database and/or data structure). Step 208 then includes comparing the stored and/or saved unknown terms to known terms (e.g., one or more enrichments) associated with a new and/or updated version of the NLP engine and determining if one or more of the unknown terms matches one or more of these known terms.

If no (that is, none of the unknown terms matches one or more of the known terms associated with a new and/or updated version of the NLP engine), the methodology 226 includes returning to step 202 with the ingestion of another document. If yes (that is, one or more of the unknown terms matches one or more of the known terms associated with a new and/or updated version of the NLP engine), then step 210 includes examining and/or processing all ingested documents to identify one or more additional documents containing the one or more unknown terms identified in connection with step 208. Additionally, step 212 then includes re-ingesting or reprocessing each of the identified one or more additional documents.

Further, step 214 includes removing the one or more unknown terms identified in connection with step 208 from the storage component (e.g., the at least one database and/or data structure noted in connection with step 206) and returning to step 202 for the ingestion of another document.

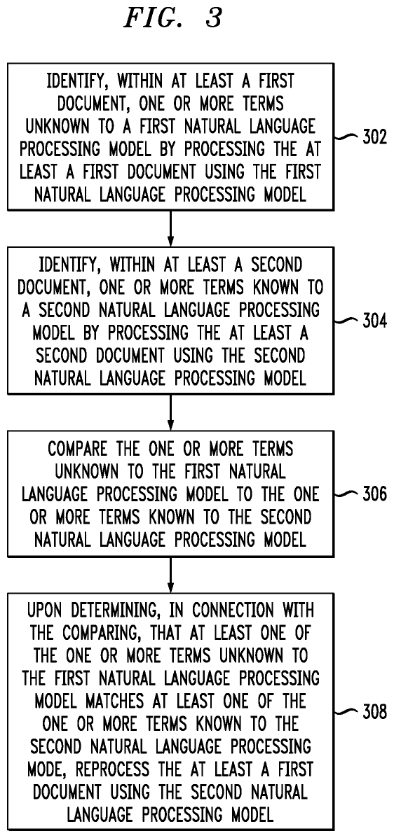

FIG. 3 is a flow diagram illustrating techniques according to an embodiment of the present invention. Step 302 includes identifying, within at least a first document, one or more terms unknown to a first natural language processing model by processing the at least a first document using the first natural language processing model. In at least one embodiment, processing the at least a first document using the first natural language processing model includes implementing one or more enrichment fields with the at least a first document, wherein the one or more enrichment fields include one or more of at least one enrichment field corresponding to one or more terms unknown to the first natural language processing model and at least one enrichment field corresponding to context information associated with one or more terms unknown to the first natural language processing model.

Also, in one or more embodiments, identifying one or more terms unknown to the first natural language processing model can include storing the one or more terms in at least one database. Such an embodiment can also include removing the terms unknown to the first natural language processing model from the at least one database subsequent to reprocessing the at least a first document using the second natural language processing model.

Step 304 includes identifying, within at least a second document, one or more terms known to a second natural language processing model by processing the at least a second document using the second natural language processing model. In at least one embodiment, the second natural language processing model includes at one of a distinct natural language processing model from the first natural language processing model and a modified version of the first natural language processing model.

Step 306 includes comparing the one or more terms unknown to the first natural language processing model to the one or more terms known to the second natural language processing model. Step 308 includes upon determining, in connection with the comparing, that at least one of the one or more terms unknown to the first natural language processing model matches at least one of the one or more terms known to the second natural language processing model, reprocessing the at least a first document using the second natural language processing model.

The techniques depicted in FIG. 3 can also include performing one or more automated actions based at least in part on the determination that at least one of the one or more terms unknown to the first natural language processing model matches at least one of the one or more terms known to the second natural language processing model. In one or more embodiments, performing one or more automated actions includes automatically training the first natural language processing model based at least in part on the determination that at least one of the one or more terms unknown to the first natural language processing model matches at least one of the one or more terms known to a second natural language processing model. Additionally or alternatively, performing one or more automated actions includes automatically identifying one or more additional documents containing the at least one term unknown to the first natural language processing model that matches at least one of the one or more terms known to the second natural language processing model. In such an embodiment, performing one or more automated actions can include automatically reprocessing each of the one or more additional documents using the second natural language processing model.

It is to be appreciated that “model,” as used herein, refers to an electronic digitally stored set of executable instructions and data values, associated with one another, which are capable of receiving and responding to a programmatic or other digital call, invocation, or request for resolution based upon specified input values, to yield one or more output values that can serve as the basis of computer-implemented recommendations, output data displays, machine control, etc. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer.

The techniques depicted in FIG. 3 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 3 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code involved in performing the inventive methods, such as enhanced document ingestion methodology code 426. In addition to code 426, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and code 426, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

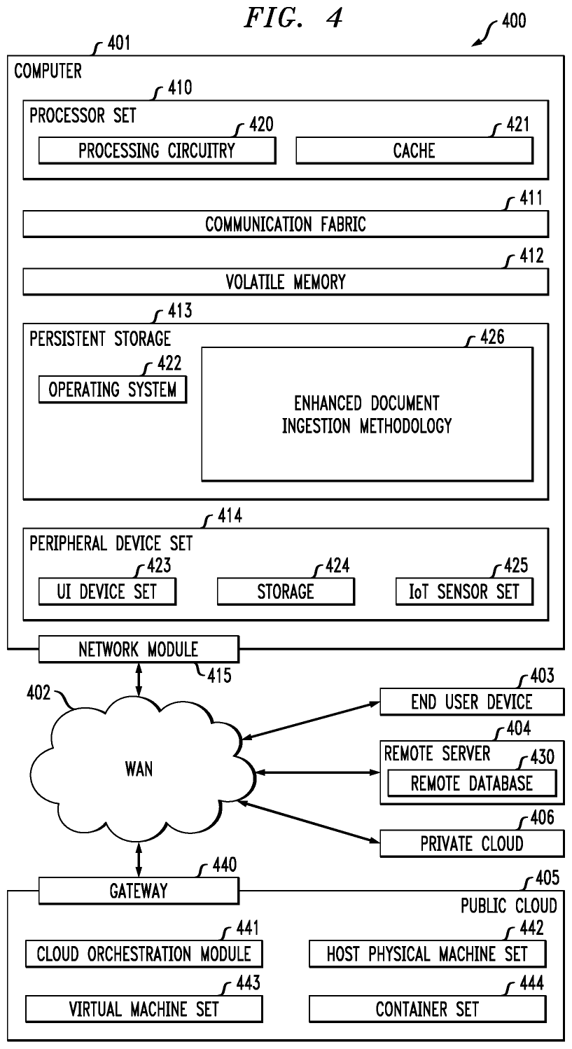

Computer 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

Processor set 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in code 426 in persistent storage 413.

Communication fabric 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 412 is any type of volatile memory now known or to be developed in the future. Examples include dynamic type RAM or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

Persistent storage 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a ROM, but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in code 426 typically includes at least some of the computer code involved in performing the inventive methods.

Peripheral device set 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

Network module 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

Remote server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

Public cloud 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

In computing environment 400, computer 401 is shown as being connected to the internet (see WAN 402). However, in one or more embodiments of the present invention, computer 401 will be isolated from communicating over communications network and not connected to the internet, running as a standalone computer. In these embodiments, network module 415 of computer 401 may not be necessary or even desirable in order to ensure isolation and to prevent external communications coming into computer 401. The standalone computer embodiments are potentially advantageous, at least in some applications of the present invention, because they are typically more secure. In other embodiments, computer 401 is connected to a secure WAN or a secure LAN instead of WAN 402 and/or the internet. In these network connected (that is, not standalone) embodiments, the system designer may want to take appropriate security measures, now known or developed in the future, to reduce the risk that incoming network communications do not cause a security breach.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
a memory configured to store program instructions; and
a processor operatively coupled to the memory to execute the program instructions to:
identify, within at least a first document, one or more terms unknown to a first natural language processing model by processing the at least a first document using the first natural language processing model;
identify, within at least a second document, one or more terms known to a second natural language processing model by processing the at least a second document using the second natural language processing model;
compare the one or more terms unknown to the first natural language processing model to the one or more terms known to the second natural language processing model; and
upon determining, in connection with the comparing, that at least one of the one or more terms unknown to the first natural language processing model matches at least one of the one or more terms known to the second natural language processing model, reprocess the at least a first document using the second natural language processing model.

2. The system of claim 1, wherein the processor is further operatively coupled to the memory to execute the program instructions to:
perform one or more automated actions based at least in part on the determination that at least one of the one or more terms unknown to the first natural language processing model matches at least one of the one or more terms known to the second natural language processing model.

3. The system of claim 2, wherein performing one or more automated actions comprises automatically training the first natural language processing model based at least in part on the determination that at least one of the one or more terms unknown to the first natural language processing model matches at least one of the one or more terms known to a second natural language processing model.

4. The system of claim 2, wherein performing one or more automated actions comprises automatically identifying one or more additional documents containing the at least one term unknown to the first natural language processing model that matches at least one of the one or more terms known to the second natural language processing model.

5. The system of claim 4, wherein performing one or more automated actions comprises automatically reprocessing each of the one or more additional documents using the second natural language processing model.

6. The system of claim 1, wherein processing the at least a first document using the first natural language processing model comprises implementing one or more enrichment fields with the at least a first document, wherein the one or more enrichment fields comprise one or more of at least one enrichment field corresponding to one or more terms unknown to the first natural language processing model and at least one enrichment field corresponding to context information associated with one or more terms unknown to the first natural language processing model.

7. The system of claim 1, wherein identifying one or more terms unknown to the first natural language processing model comprises storing the one or more terms in at least one database.

8. The system of claim 7, wherein the processor is further operatively coupled to the memory to execute the program instructions to:
remove the terms unknown to the first natural language processing model from the at least one database subsequent to reprocessing the at least a first document using the second natural language processing model.

9. The system of claim 1, wherein the second natural language processing model comprises at one of a distinct natural language processing model from the first natural language processing model and a modified version of the first natural language processing model.

10. A computer program product comprising a computer readable storage medium having program instructions embodied therewith, the program instructions executable by a computing device to cause the computing device to:
identify, within at least a first document, one or more terms unknown to a first natural language processing model by processing the at least a first document using the first natural language processing model;
identify, within at least a second document, one or more terms known to a second natural language processing model by processing the at least a second document using the second natural language processing model;
compare the one or more terms unknown to the first natural language processing model to the one or more terms known to the second natural language processing model; and
upon determining, in connection with the comparing, that at least one of the one or more terms unknown to the first natural language processing model matches at least one of the one or more terms known to the second natural language processing model, reprocess the at least a first document using the second natural language processing model.

11. The computer program product of claim 10, wherein the program instructions executable by a computing device further cause the computing device to:
perform one or more automated actions based at least in part on the determination that at least one of the one or more terms unknown to the first natural language processing model matches at least one of the one or more terms known to the second natural language processing model.

12. The computer program product of claim 11, wherein performing one or more automated actions comprises automatically training the first natural language processing model based at least in part on the determination that at least one of the one or more terms unknown to the first natural language processing model matches at least one of the one or more terms known to a second natural language processing model.

13. The computer program product of claim 11, wherein performing one or more automated actions comprises automatically identifying one or more additional documents containing the at least one term unknown to the first natural language processing model that matches at least one of the one or more terms known to the second natural language processing model.

14. The computer program product of claim 13, wherein performing one or more automated actions comprises automatically reprocessing each of the one or more additional documents using the second natural language processing model.

15. A computer-implemented method comprising:
identifying, within at least a first document, one or more terms unknown to a first natural language processing model by processing the at least a first document using the first natural language processing model;
identifying, within at least a second document, one or more terms known to a second natural language processing model by processing the at least a second document using the second natural language processing model;
comparing the one or more terms unknown to the first natural language processing model to the one or more terms known to the second natural language processing model; and
upon determining, in connection with the comparing, that at least one of the one or more terms unknown to the first natural language processing model matches at least one of the one or more terms known to the second natural language processing model, reprocessing the at least a first document using the second natural language processing model;
wherein the method is carried out by at least one computing device.

16. The computer-implemented method of claim 15, further comprising:
performing one or more automated actions based at least in part on the determination that at least one of the one or more terms unknown to the first natural language processing model matches at least one of the one or more terms known to the second natural language processing model.

17. The computer-implemented method of claim 16, wherein performing one or more automated actions comprises automatically training the first natural language processing model based at least in part on the determination that at least one of the one or more terms unknown to the first natural language processing model matches at least one of the one or more terms known to a second natural language processing model.

18. The computer-implemented method of claim 16, wherein performing one or more automated actions comprises automatically identifying one or more additional documents containing the at least one term unknown to the first natural language processing model that matches at least one of the one or more terms known to the second natural language processing model.

19. The computer-implemented method of claim 18, wherein performing one or more automated actions comprises automatically reprocessing each of the one or more additional documents using the second natural language processing model.

20. The computer-implemented method of claim 15, wherein software implementing the method is provided as a service in a cloud environment.
